(19) United States
(12) Patent Application Publication
(10) Pub. No.: US 2009/0327152 A1
(43) Pub. Date: Dec. 31, 2009

(54) PORTFOLIO MANAGEMENT TOOL

(76) Inventor: Richard Charles Leighton Davis, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/994,187

(22) PCT Filed: Jul. 1, 2005
(86) PCT No.: PCT/AU05/00958

§ 371 Date: Sep. 15, 2009

(51) Int. Cl. G06Q 40/00

(52) U.S. Cl. 705/36 R; 705/37

(57) ABSTRACT

A method and apparatus for determining a personal rate of return over a plurality of time frames for a financial product included by an investor in a portfolio comprising the steps:
a) obtaining data from a data provider;
b) adjusting the data for frictional effects;
c) allocating a first time;
d) allocating a second time;
e) determining the personal rate of return between the first time and the second time.

### BACKGROUND

The present invention relates to the field of portfolio analysis and more particularly to a method and apparatus for securely determining a personal investment return for a portfolio of financial products subject to particular investment decisions over a plurality of differing time frames in a secure and credentialed system.

Whilst the prior art in the field of portfolio investment analysis teaches the ability to determine an annualized rate of return for a given financial product. The prior art is deficient in various respects.

Firstly, financial products in a typical portfolio can include a range of products from traded securities such as shares, to unlisted products, futures, investments in residential or commercial property, all of which can have differing rates of returns.

Further, whilst many publicly retailed financial products may have published rates of returns associated with them, it is often surprising to investors to discover that when the effects of transaction costs, such as brokerage rates, management fees, or inflation, to name just a few factors are included that their rates of return can be quite different. Further, the published rates of returns of institutions reflect the cash flow of the institutional fund as distinct from the actual cash flow realized by a potential investor. The individual needs to determine a rate of return based upon all factors that are relevant to his or her personal investment experience needs and objects.

Naturally, as a result of government pressure, a worldwide trend has developed towards increased disclosure and transparency of such otherwise hidden costs in the financial services industry. However, many investors do not readily have a means to calculate their real personal rates of return when the effects of these transactional costs are included, thereby making it difficult for investors to select between a plurality of competing financial products.

Once the effects of transactional costs and management fees are included many investors are actually surprised to find that elements of their investment portfolio actually have a negative rate of return over a period in question. In the case of retirees for example, whose income generation from their investment may be their only source of income, then the need to maximize their rate of return can be quite significant. For such persons selecting a financial product based upon a rate of return which superficially appears attractive given published information, but which for their personal investment time frames actually leads to a negative or sub optimal rate of return can mean that such persons have inadequate moneys to fund their retirement, thereby rendering such persons either as a burden upon their relatives or upon the public purse.

The actual time period or periods in which the investor has or can invest their moneys can become quite significant. Often published rates of return whilst adequately representing the rates of return over a period in question can be chosen deliberately to exclude events which if included may have otherwise significantly reduced a published rate of return. For example, a published rate of return, which included a significant proportion of risk prone stocks which chose to publish returns for a time frame that did not include the time frame associated with what has become known as the “tech wreck” in the year 2000, in say the case of software stocks, then this scenario could give a potential investor an inaccurate and unhelpful perspective as to the expected rate of return that can consistently be obtained. Conversely, a time frame which chose to include an unusually positive period could also create a misleading impression. For example, a published rate of return for a portfolio which focused exclusively upon oil stocks during a time of unusually high energy prices could give a misleading impression that such a rate of return can consistently be secured by way of investment in energy stocks, a similar argument would apply in relation to property stock investment wherein the published return for a fund tilted towards the property sector, which chose to include or exclude major rises and falls in underlying property prices in its time frames for calculating rates of return could give an unhelpful or incorrect impression that such rates of return could consistently be achieved.

Further, the ability to receive data which enables an investor to determine their personal rates of return either actually or hypothetically would obviously need to be performed in a secure manner to protect investor confidence and the integrity of client data. Further, the security of the institutions in which the client considers investing his or her moneys is also a relevant consideration. Many clients for example upon seeing a lower than otherwise expected rate of return can choose to invest their moneys in different financial products or with different financial institutions.

Financial institutions considering accepting new clients, will typically require the client to establish that they have sufficient credentials in order to commence trading or investing in various financial products with a new institution. Therefore, it is necessary not only for the investor to receive information from institutions in a secure manner, but in order to use the benefit of the data produced by the present invention in an efficient manner, it is also desirable for the investor to be able to securely identify themselves with a new institution in an efficient manner (so as to facilitate transfer of investments from one institution to another in a timely manner, without the need to fill out extensive forms to repeat credentialing.)

Appropriate credentialing is necessary not only to protect a new institution against a failure of a client to settle their trades but it also protects the community as a whole against fraudulent practices associated with criminal conduct such as money laundering or unhelpful advice from a financial adviser.

A need exists for an investor to be able to determine a personal rate of return for a given portfolio over a plurality of different time frames, so as to compare this value with published values, which may be based upon different time frames and accordingly which may not be indicative of the portfolio performance of the investor and therefore otherwise unhelpful.

A need exists for the personal rate of return to include adjustments relating to transaction costs, such as management fees, stamp duty, governmental charges, commissions, bank fees, margin costs, interest costs on borrowed money to fund a transaction, costs of currency conversion, some of which are typically referred to as frictional costs.

A need exists for the personal rate of return to include factors which may alter the calculation of the market price of a financial product, which forms a component of the portfolio based upon a plurality of factors such as share splits, dividend distribution, rights issues, share consolidation, name changes, code changes to redefine the identity of financial product all of which can structurally redefine the value of the product.

Additional factors can also be included which permit the impact of gearing either being included or excluded, or the effect of large cash balances to provide analysis of the impact of pursuing a fully invested strategy. The return on large cash balances can also be factored in either as a component of investment return in the portfolio or as a component of interest paid to the investor in the case of a cash account with a third party debit authority being given to a broker to settle trades. Thereby, giving rise to interest on the account when not trading.

A need exists for an investor to be able to download and to communicate with financial institutions in a secure manner and appropriately credentialed manner so as to receive data for the purpose of determining an investor's real personal rate of return at any time for any time period and to enable the investor to shift their investment weighting between different financial products which can include products offered by a new financial institution.

A need exists for an investor to be provided with the ability to rapidly enter into a credentialed trading relationship with a new trading institution.

It is an object of the present invention to enable an investor to determine a personal rate of return for a given portfolio over a plurality of different time frames, so as to compare this value with published values, which may be based upon different time frames and accordingly which may not be indicative of the portfolio performance of the investor and therefore unhelpful.

It is an object of the present invention to ensure that the personal rate of return can include adjustments such as transaction costs, management fees and brokerage which are typically referred to as frictional costs.

It is an object of the present invention to ensure that the personal rate of return can include factors which may alter the calculation of the market price of a financial product, which forms a component of the portfolio based upon a plurality of factors such as share splits, bonuses, rights issues, consolidations, dividend distribution, which may structurally redefine the value of the product.

It is an object of the present invention to enable the investor to be able to download and to communicate with financial institutions in a secure manner and appropriately credentialed manner so as to receive data for the purpose of determining their real personal rate of return and to enable the investor to shift their investment weighting between different financial products which can include products offered by a new financial institution.

It is an object of the present invention enable an investor to enter into a secure trading arrangement with a new financial institution and to thereby avoid the otherwise time consuming process of filling out credentialing forms with associated delay.

It is an object of the present invention to address or at least ameliorate some of the above disadvantages.

### BRIEF DESCRIPTION OF INVENTION

The present invention relates to the field of investment portfolio analysis and more particularly to a method and apparatus for securely determining a personal investment return for a portfolio of financial products subject to particular investment decisions over a plurality of differing time frames in a secure and credentialed system.

The present invention eliminates or at least partially ameliorates the problems associated with unhelpful and potentially misleading presentation of published rates of return which may not represent a rate of return achieved over a time frame which is of benefit to an investor.

The present invention eliminates or at least partially ameliorates the problem associated with unrepresentative rates of returns for financial products and portfolios which do not provide the investor with all relevant information.

The present invention eliminates or at least partially ameliorates the problem associated with artificially high rates of returns for financial products which do not include factors which may alter the calculation of the market price of a financial product, which forms a component of the portfolio based upon a plurality of factors such as share splits, dividend distribution, currency conversion rates, which may structurally redefine the value of the product.

The present invention eliminates or at least partially ameliorates the problems related to detailed credentialing and security associated with an investor deciding to transfer a portion of their portfolio to a new financial institution based upon a comparison of their personal rate of return with a published rate of return or against their own investment objectives.

The present invention eliminates or at least partially ameliorates the need for an investor to engage in the otherwise time consuming process of filling out credentialing forms so as to enter into a secure trading arrangement with a new financial institution.

In one broad form of the invention there is provided a method for determining a personal rate of return over a plurality of time frames for a financial product included by an investor in a portfolio comprising the steps:

a) obtaining data from a data provider;
b) adjusting the data for frictional effects;
c) allocating a first time;
d) allocating a second time;
e) determining the personal rate of return between the first time and the second time.

Preferably, the method above wherein adjustments are made to the data for structural effects.

Preferably, the method above wherein adjustments are made for cash balances.

Preferably, the method above wherein gearing is included as an adjustment.

Preferably, the method above wherein the investor can move elements of the portfolio from a first financial institution to a second financial institution.

Preferably, the method above wherein agreements exist between the first financial institution and the data provider and the second financial institution and the data provider so as to facilitate the investor rapidly changing the elements of the portfolio from the first financial institution to the second financial institution in a secure and credentialed manner.

Preferably, the method above wherein the elements of the portfolio can be invested in a first financial product offered by the first financial institution.

Preferably, the method above wherein the elements of the portfolio can be invested in a second financial product offered by the second financial institution.

Preferably, a business method adapted to perform the steps above.

Preferably, software adapted to perform the steps above.

Preferably, a device adapted to perform the steps above.

Preferably, a portable device adapted to perform the steps above.

Preferably, a digital system adapted to perform the steps above.

Preferably, hardware adapted to perform the steps above.

Preferably, media adapted to perform the steps above including:

a) a central processing unit;
b) a memory storage device.

Preferably, the media which further comprises a control card.

Preferably, the media which further comprises a graphics card.

### BRIEF DESCRIPTION OF DRAWINGS

FIG. 1 discloses a preferred embodiment of the present invention in which a digitized system, which includes a computer and software, is adapted to calculate a personal rate of return for an investor.

FIG. 2 discloses the steps involved in calculating a personal rate of return according to the embodiment shown in FIG. 1.

FIG. 3 discloses a graph of a plurality of different rates of return calculated according to the embodiment disclosed in FIG. 1.

FIG. 4 is an expanded view of the computer disclosed in FIG. 1, which includes media, adapted to calculate a personal rate of return.

### DETAILED DESCRIPTION OF PREFERRED EMBODIMENTS

Embodiments of the present invention will now be described with reference to the accompanying drawings wherein:

The term “method” is used in this specification can includes in the alternative a business method.

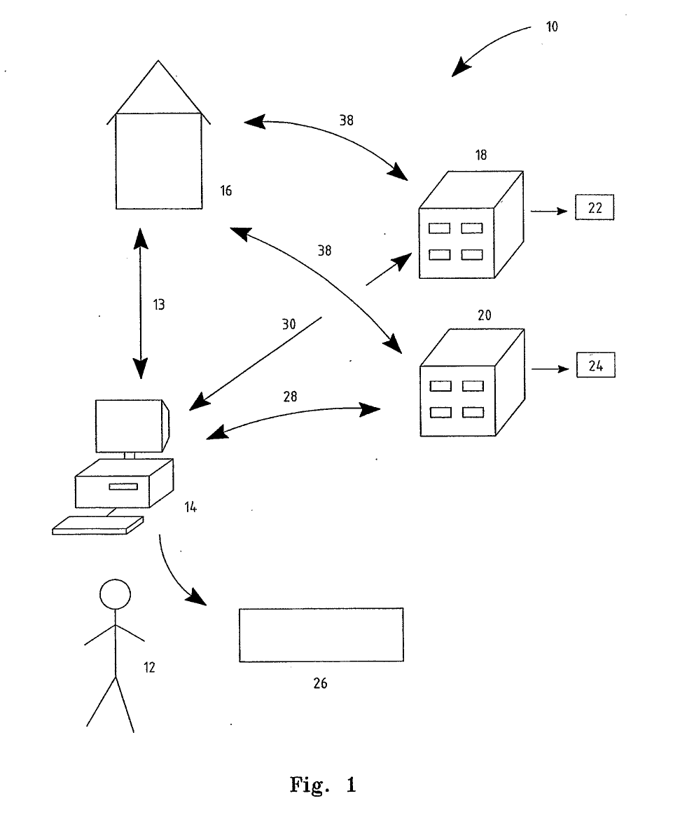

FIG. 1 discloses a method, system and apparatus according to a present embodiment.

The system 10 provides an apparatus which can include software 11. The apparatus according to the present embodiment as shown in FIG. 1 can take the form of a computer 14.

The investor 12 operates the computer 14. The investor 12 can be provided with all software 11 necessary to obtain full functionality of the embodiment, according to a present embodiment. Alternatively, the investor 12 can obtain the results only.

The investor 12 can obtain a continuous download of data 13 from a data provider 16. The data provider 16 can provide the investor with pricing, transaction, dividend and other relevant information pertaining to the financial portfolio of the investor 12. The data can include adjustments for frictional costs, which can include transaction costs, entry fees, exit fees, management costs, and other relevant factors which without limitation can reduce the rate of return of the investor's portfolio in respect to various financial products.

The investor 12 can purchase financial products from a first financial institution 18. The investor 12 can purchase financial products from a second financial institution 20. The investor can purchase a first financial product 22 from the first financial institution 18. The investor can purchase a second financial product 24 from the second financial institution 24. The first financial product 22 and the second financial product 24 can be included in the investor's financial portfolio.

The communication between the first financial institution 18 and the investor 12 can be secure and credentialed. Credentialing can take a plurality of forms from the identification of the investor 12 for the purposes of ensuring disclosure of relevant taxation details, to obtaining all necessary information about investor's investment holdings so as to form a comprehensive picture of the individual's particular investment needs. The communication between the first financial institution 18 and the second financial institution 20 can be secure and credentialed. If the investor 12 is only credentialed to deal in a secure and authorized manner with the first financial institution 18 then the investor 12 can be required to complete extensive documentation in order to deal in a secure and credentialed manner with the second financial institution 20. The present embodiment can provide agreements between the data provider 16 and the first financial institution 18 to enable the investor 12 to deal with the first financial institution 18 in a secure and credentialed manner according to a first credentialed communication 30. A plurality of different methods of downloading of data 13 can be envisaged in which data can alternatively be directly downloaded from a financial institution or alternatively from another third party. The investor 12 can be credentialed to perform a download himself or herself. Alternatively, such credentialing cannot be granted in an alternative embodiment, in which case the download will be performed by a third party for the investor 12 (the investor 12 then not having the knowledge personally as to how to download the data 13). The present embodiment can provide an agreement 38 between the data provider 16 and the second financial institution 20 to enable the investor 12 to deal with the second financial institution 20 in a secure and credentialed manner according to a second credentialed communication 28.

The institutional agreement 38 used in association with the computer 14 permits the investor 12 to transfer his or her dealings between the first financial institution 18 and the second financial institution 20 with a minimum of effort.

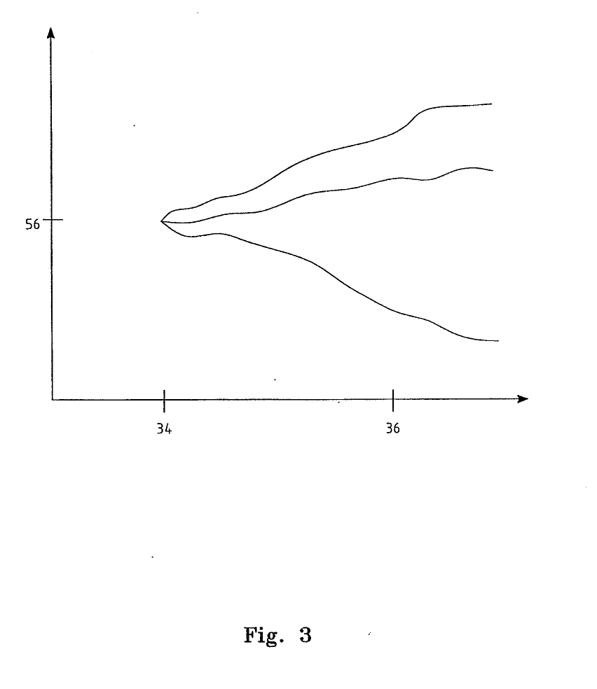

The first financial institution 18 and the second financial institution 20 can publish rates of return pertaining to a first financial product 22 and a second financial product 24. The investor 12 can calculate his or her personal rate of return 26 for comparison with published rates for a plurality of financial products by selecting a first time 34 and a second time 36, as shown in FIG. 3, and then using the computer 14 which can include software 11 according to the present embodiment so as to determine the investor's personal rate of return 26. In a preferred embodiment the first time can be the time when the investor 12 first puts his or her moneys into a financial product.

The computer 14 can include instructions either in the form of software or hard coded instructions as hardware. Similarly, the computer 14 can include or be replaced by a device which can be portable. The computer 14 can be incorporated into a digital system so as to perform the steps of the present embodiment. Further, the present embodiment can be included as a component of a business method.

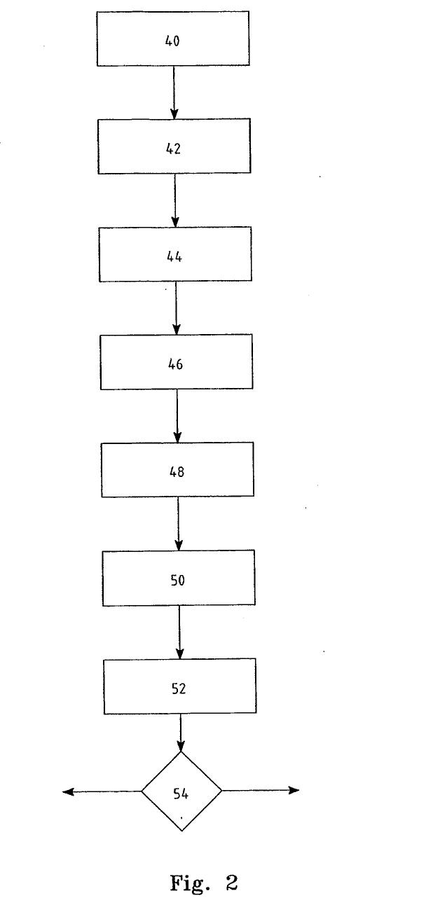

FIG. 2 displays the process that can occur in the computer 14.

Step 40 displays the step of downloading data from the data provider 16.

Step 42 shows updating for frictional effects an investor's portfolio.

Step 44 shows the updating of data pertaining to the investor's portfolio for structural changes to a financial product, which can include share splits, bonus issues, dividend disbursement.

Once all data 13 has been updated for frictional and structural effects the user can then select various time frames for determination of his or her personal rate of return 26. The investor can alternatively select the time frames by choosing a first time 34 and a second time 36 and then the data 13 can be updated for a given frame in another preferred embodiment.

Step 46 pertains to the investor 12 selecting a first time.

Step 48 pertains to the investor 12 selecting a second time.

Step 50 then shows the process of the computer 14 determining a personal rate of return 26 according to an embodiment 10.

Step 52 shows the process of the investor 12 comparing his or her personal rate of return 26 with that of the personal rate of return for a first financial product 22. The investor can also compare their personal rate of return 26 with a plurality of other financial products which can include a second financial product 24. The first financial product can be offered by a first financial institution 18. The second financial product can be offered by a second financial institution 20.

Step 54 shows the process of the investor 12 using the personal rate of return, which has been adjusted for frictional costs and structural changes to the price of a financial product to determine whether or not to change components of his or her investment portfolio.

### In Use

As seen in FIG. 1, in use an investor 12 can use the computer 14 equipped with software 11 in order to communicate with a data provider 16 so as to determine his or her personal rate of return 26. The investor 12 can then compare his or her personal rate of return 26 for his or her portfolio with rates of return for different financial products which can include a first financial product 22 and a second financial product 24. Such calculations can also be used to compare the benefits of using a plurality of dollar cost averaging strategies (buying or selling on a number of occasions at discrete intervals over a period of time so as to average a buy or sell price). The investor 12 can then determine with the benefit of agreements 38 to switch the weighting of his or her investments between different financial products without the need to engage in what can otherwise be the completion of extensive paperwork and supporting documentation and accompanying delays. The investor 12 can make a decision based upon a personal rate of return 26 which has been adjusted for frictional factors such as inflation, management costs, brokerage commissions, administrative charges and entry and exit costs and structural changes to the financial product.

In use the calculation of a personal rate of return 26 can facilitate the determination of realistic performance standards for a typical investor 12. The investor 12 then has greater control over his or her investing strategy when equipped with such additional information and therefore is more informed to make an effective investment decision. In addition other public benefits accrue in that institutions are also compelled to be more competitive and transparent and consistent in relation to their information disclosures.

In use the calculation of a personal rate of return 26 can be used to rank portfolios and funds or other financial products upon daily monthly, quarterly, biannual or annual or other periodic basis so as to encourage greater competition between institutions offering financial products.

In use the embodiment 10, will enable an investor to dissect a packaged portfolio of financial products according to their own personal needs and experience, so as to obtain greater control and to act in a more informed manner in deciding how to allocate his or her moneys.

In use the investor 12 is able to according to the present embodiment to compare the costs of a first product 22 and a second financial product 24 or different financial advisers on a like-for-like basis, and use that information to provide assistance in negotiating lower costs or achieving other material benefits.

In use the investor 12 is able according to the present embodiment to experiment with different possible choices of investment vehicles so as to be in a position to maximize his or her potential personal investment return 26. The investor 12 is thereby able to make appropriate selections based on similar analysis of actual historical information about various financial products that suit the investor's individual needs. The lack of integration of frictional factors, structural factors and of the fixed time periods in data disclosing rates of return can create incorrect impressions or at the very least yield unhelpful comparisons. Accordingly, the embodiment can be used to provide increased accuracy and transparency in the presentation of financial information.

Without real time integration of frictional and structural factors with pricing information then the process of selection on the same basis would be extremely time consuming. The embodiment can produce results that appear counter intuitive in that standard published rates of return for various portfolios and funds, which can give rankings or returns that differ significantly in both performance and ranking from those obtained from current published information. Investors can often be surprised to learn that various funds, can actually lead to negative rates of return once the timing of an investor's deposits and withdrawals are included.

An embodiment can identify a loss of opportunity in relation to an investment portfolio, as indicated by a suboptimal return. Typically, large losses occur by moneys being eroded by the effects of inflation or by achieving a lower return than other parts of a portfolio as investments lay in dormant assets or cash. In addition to eliminating problems associated with opportunity loss an embodiment can be used to check the accuracy of different data feeds and to provide mechanisms so that individuals can ensure the completeness and the accuracy of information presented to individuals by institutions.

FIG. 1 displays the communication of the investor 12 through the computer 14 with a plurality of entities which can include a data provider 16 and a first financial institution 18 and a second financial institution 20. An embodiment according to FIG. 1 can be used to cross check the accuracy of the respective data feeds received by the investor 12 so as to ensure that gaps or errors in information received by the investor 12 are eliminated or highlighted.

The present embodiment is to be construed in a non limiting manner. Preferably, calculating the investor's personal rate of return 26 over multiple time frames can be used to examine different investments scenarios. A plurality of different financial products can be examined. A plurality of different portfolios can be analyzed. A plurality of different frictional costs can be analyzed, and a plurality of different financial institutions can be compared according to the actual experience of their existing customers or according to the actual activity of the investor. A plurality of different funds can be compared to determined their effective (net of frictional costs and other adjustments) rates of return. Similarly, a personal rate of return 26 can be calculated in a plurality of differing ways. A personal rate of return 26 can be calculated against a normalized base starting figure of $1000 or the rate can be determined based upon an arbitrary starting figure. However, for graphical purposes a net figure of $1000 can be used to display comparative investment performance.

FIG. 3 displays a plurality of different financial products being compared on a single graph. The investment amounts are normalized to a base amount 56. The base amount can be $1000 or another arbitrarily chosen figure. The performance of each financial product, net of frictional and structural adjustments is then compared. Surprisingly, to many investors, as indicated by the lower most graph in FIG. 3 a so called conservative or secure form of investment can often yield real losses as the investor's money is slowly eaten away as a result of frictional effects. Calculation of graphically presented investment returns can occur at a plurality of different points in time. These points can be substantially instantaneous, subject to data feed delay, or of a more extended nature such as at the end of a day or a month. Further, the investor 12 can have the option of inputting their own transaction pricing dividend or other data into the computer 14 so as to update the analysis or to use the embodiment to measure the returns achieved by the individual from transactions in assets for which there is no readily available market price, or to examine their personal rate of return for different time periods. Alternatively, an investor can input sample experimental transactions to examine potential returns against actual returns or against other financial products.

Such calculations can include data that can be old. Such calculations can alternatively be based upon live data feeds.

The present embodiment also provides the user with the ability to select different time periods based upon taxation years. A user can conduct an analysis for the present taxation year or a previous taxation year. Further, information can be used to assist in the preparation of taxation information for different taxation periods, be they quarterly or annual for example. Such material is also of assistance in helping investors and investment managers to estimate their cash flows on a quarterly basis.

In a further preferred embodiment, the embodiment can also distinguish between returns derived from dividend and other distributions within a portfolio and those derived from capital gains. Typically, this information can be quite useful in that various sectors of the market such as mining stocks are often preferred for persons seeking short term capital gains whereas other sectors, such as a property stock can often only provide marginal forms of capital gain in the short term but can provide attractive dividends. Further, the calculation and reporting of returns on capital gains and distributions can occur separately so as to conform to established reporting standards.

In a further preferred embodiment the investor can compare different returns produced by the embodiment with returns calculated on the same basis which have been achieved by a plurality of other investors over the same time period.

A further preferred embodiment can also provide a regulatory organization with a tool to enable it to objectively measure whether the investments made on an investor's behalf by a financial institution on behalf of that investor actually go some way towards those goals.

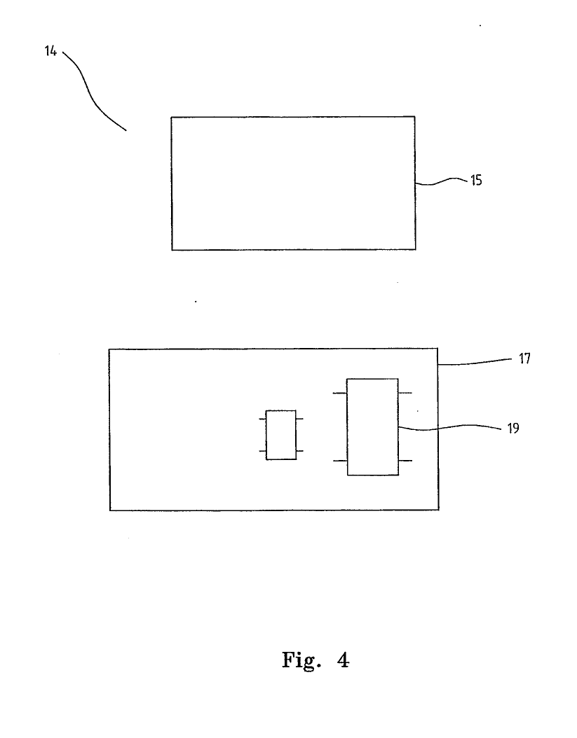

FIG. 4 discloses an expanded image of the device 14 which includes a viewing screen 15, a computer processor 17 and a keyboard 21. The computer processor 17 includes media 19. The media 19 can include a control card, a graphics card, a central processing unit and a memory storage device.

1. A method for quantifying a personal actual achieved rate of return over a plurality of time frames for a financial product investment included by an investor in a portfolio comprising the steps:
a) obtaining data from a data provider including market data;
b) adjusting the data for frictional effects;
c) obtaining transaction data including transaction data in the form of personal actual amounts invested in said financial product investment;
d) allocating a first time;
e) allocating a second time;
f) determining the personal rate of return between the first time and the second time as an output of the investment for said financial product thereby to compare performance and the components of performance relevant to said investor between a first financial product and a second financial product between said first time and said second time.

2. The method according to claim 1 wherein adjustments are made to the data for structural effects.

3. The method of claim 1 wherein said financial product investment includes a portfolio of products.

4. The method of claim 1 wherein said financial product investment comprises an investment in the same financial product over a different timeframe of investment.

5. The method of claim 1 wherein said components of performance include one or more of quantification of frictional effects in a standardised manner, commissions, taxes, management fees.

6. The method of claim 1 wherein said method is applied to each said financial product in said portfolio thereby to derive a personal rate of return for said portfolio.

7. The method according to claim 1 wherein adjustments are made for cash balances.

8. The method according to claim 1 wherein gearing is included as an adjustment.

9. The method according to claim 1 wherein the investor can move elements of the portfolio from a first financial institution to a second financial institution.

10. The method according to claim 1 wherein agreements exist between the first financial institution and the data provider and the second financial institution and the data provider so as to facilitate the investor rapidly changing the elements of the portfolio from the first financial institution to the second financial institution in a secure and credentialed manner.

11. The method according to claim 1 wherein the elements of the portfolio can be invested in a first financial product offered by the first financial institution.

12. The method according to claim 1 wherein the elements of the portfolio can be invested in a second financial product offered by the second financial institution.

13. The method of claim 1 wherein said method is applied to a first portfolio held by a first investor and a second portfolio held by a second investor thereby to quantify personal actual achieved rate of return by said first investor and said second investor and thereby to compare personal actual achieved rate of return achieved by each of said first investor and said second investor.

14. Software adapted to perform the steps according to claim 1.

15. A device adapted to perform the steps according to claim 1.

16. A portable device adapted to perform the steps according to claim 1.

17. A digital system adapted to perform the steps according to claim 1.

18. Hardware adapted to perform the steps according to claim 1.

19. Media adapted to perform the steps according to claim 1, the media including:
a) a central processing unit;
b) a memory storage device.

20. The media according to claim 19 which further comprises a control card.

21. The media according to claim 19 which further comprises a graphics card.

22. A method of dealing in an investment portfolio of an investor; said portfolio comprising a plurality of distinct investment elements administered by an at least first financial institution on behalf of said investor; said method of dealing comprising a facility whereby the investor can move at least selected ones of said elements of the portfolio from a first financial institution to a second financial institution.

23. The method of claim 22 wherein agreements exist between the first financial institution and a data provider and the second financial institution and the data provider so as to facilitate the investor rapidly changing the elements of the portfolio from the first financial institution to the second financial institution in a secure and credentialed manner.

24. The method according to claim 22 wherein the elements of the portfolio can be invested in a first financial product offered by the first financial institution.

25. The method according to claim 24 wherein the elements of the portfolio can be invested in a second financial product offered by the second financial institution.

26. The method of claim 22; said method further including a method for determining a personal rate of return over a plurality of time frames for a financial product included by said investor in a portfolio comprising the steps:
a) obtaining data from a data provider;
b) adjusting the data for frictional effects;
c) allocating a first time;
d) allocating a second time;
e) determining the personal rate of return between the first time and the second time.

27. The method of claim 26, said method further including quantifying a personal actual achieved rate of return over a plurality of time frames for a financial product investment included by an investor in a portfolio comprising the steps:
a) obtaining data from a data provider including market data;
b) adjusting the data for frictional effects;
c) obtaining transaction data including transaction data in the form of personal actual amounts invested in said financial product investment;
d) allocating a first time;
e) allocating a second time;
f) determining the personal rate of return between the first time and the second time as an output of the investment for said financial product thereby to compare performance and the components of performance relevant to said investor between a first financial product and a second financial product between said first time and said second time.

28. The method according to claim 26 wherein adjustments are made to the data for structural effects.

29. The method according to claim 28 wherein adjustments are made for cash balances.

30. The method according to claim 26 wherein gearing is included as an adjustment.

31. The method according to claim 26 wherein frictional costs are included as an adjustment.

32. The method of claim 26 wherein said financial product investment includes a portfolio of products.

33. The method of claim 26 wherein said financial product investment comprises an investment in the same financial product over a different timeframe of investment.

34. The method of claim 26 wherein said components of performance include one or more of quantification of frictional effects in a standardised manner, commissions, taxes, management fees.

35. The method of claim 26 wherein said method is applied to each said financial product in said portfolio thereby to derive a personal rate of return for said portfolio.
